(19) United States
(12) Patent Application Publication
(10) Pub. No.: US 2015/0286028 A1
(43) Pub. Date: Oct. 8, 2015

(54) Follow Focus Apparatus

(71) Applicant: Patrick Sean McCurry, McDonough, GA (US)

(72) Inventor: Patrick Sean McCurry, McDonough, GA (US)

(21) Appl. No.: 14/670,591

(22) Filed: Mar. 27, 2015

Related U.S. Application Data
(60) Provisional application No. 61/995,178, filed on Apr. 5, 2014.

(51) Int. Cl. G02B 7/04

(52) U.S. Cl. CPC G02B 7/04

(57) ABSTRACT

A follow focus apparatus for adjusting the focus of a camera lens includes a circular gear ring having opposed inner and outer surfaces and defining an open interior area, the inner surface having a planar configuration. A plurality of spaced apart teeth are situated on the outer surface of the gear ring. The apparatus includes a sizing member selectively received in a cutout area defined by an inner surface of the gear ring so as to decrease an inner diameter by a predetermined amount. The apparatus includes a sizing ring having a configuration received in the gear ring interior area, the sizing ring being configured to decrease the inner diameter of the gear ring by a predetermined amount. The sizing ring includes an outwardly extending projection configured to nest in corresponding notches defined by the gear ring inner surface so as to secure the sizing ring in the gear.

### REFERENCE TO RELATED APPLICATION

This non-provisional patent application claims the benefit of provisional application Ser No. 61/995,178 filed on Apr. 4, 2014, titled Pressure Fit Seamless Follow Focus Gear.

### BACKGROUND OF THE INVENTION

This invention relates generally to camera devices and, more particularly, to a follow focus apparatus that may be operatively coupled to a lens of a camera to more accurately and efficiently focus the lens.

A follow focus is an apparatus that is used in filmmaking or in the use of a camera lens where changes in focus need to be made quickly and smoothly. The follow focus is not actually part of the lens or used for capturing an image but rather to efficiently and precisely move and focus the lens. The follow focus may be coupled directly to the front of the lens so as to surround the lens or may be mounted alongside the lens and use a linkage for move the lens. As the follow focus is rotated, the lens is rotated and focused accordingly. Gripping a set of teeth on the focus follow ring is generally more successful than gripping the lens ring itself, although that is also possible.

One difficulty experienced with existing follow focus rings is that they do not fit all camera lenses universally. Thus, an undesirably large number of follow focus rings are necessary for filmmaker using multiple lenses, such as with a complex telephoto lens camera. Related to this disadvantage, a follow focus is unreliable if it does not fit tightly over a camera lens, i.e. rotation of the follow focus ring might not reliably turn and focus the camera lens.

Therefore, it would be desirable to have a follow focus apparatus having sizing accessories configured to enable a gear ring to be securely coupled to the lens ring of a camera.

### SUMMARY OF THE INVENTION

A follow focus apparatus for adjusting the focus of a camera lens according to the present invention includes a gear ring that includes a cylindrical configuration having an inner surface, an outer surface opposite the inner surface and defining an open interior area, the inner surface having a planar configuration. A plurality of teeth are situated on the outer surface of the gear ring and spaced apart from one another. The apparatus includes a sizing member selectively received in a cutout area defined by an inner surface of the gear ring so as to decrease an inner diameter thereof by a predetermined amount. The apparatus includes a sizing ring having a configuration received concentrically in an interior area of the gear ring, the sizing ring being configured to decrease the inner diameter of the gear ring by a predetermined amount. The sizing ring includes an outwardly extending projection configured for insertion into corresponding notches defined by an inner surface of the gear ring so as to secure the sizing ring in the gear.

Therefore, a general object of this invention is to provide a follow focus apparatus having a gear ring that includes a generally cylindrical configuration complementary to a camera lens ring, the gear ring having a smooth inner surface and an opposed outer surface having a plurality of spaced apart teeth.

Another object of this invention is to provide a follow focus apparatus, as aforesaid, having sizing members that may be inserted into one or more cutouts defined by an inner surface of the gear ring so as to decrease an inner diameter of the gear ring a predetermined amount—thus creating a secure fit onto a camera lens having a smaller diameter.

Still another object of this invention is to provide a follow focus apparatus, as aforesaid, having a sizing ring that includes a diameter concentrically smaller than the gear ring so as to decrease the inner diameter thereof when inserted into the interior space of the gear ring.

A further object of this invention is to provide a follow focus apparatus, as aforesaid, in which an inner diameter of the gear ring has a sloping and decreasing diameter so as to secure the sizing ring with the interior area thereof.

A still further object of this invention is to provide a follow focus apparatus, as aforesaid, in which the sizing ring includes a plurality of projections having a shape configuration complementary to recessed areas defined by the inner surface of the gear ring.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a focus follow apparatus according to an embodiment of the present invention;

FIG. 2a is a perspective view of a follow focus apparatus according to another embodiment of the present invention;

FIG. 2b is an exploded view of the follow focus apparatus as in FIG. 2a;

FIG. 3a is a perspective view of a follow focus apparatus according to another embodiment of the present invention;

FIG. 3b is an exploded view of the follow focus apparatus as in FIG. 3a;

FIG. 4a is a perspective view of a follow focus apparatus according to another embodiment of the present invention;

FIG. 4b is an exploded view of the follow focus apparatus as in FIG. 4a.

### DESCRIPTION OF THE PREFERRED EMBODIMENT

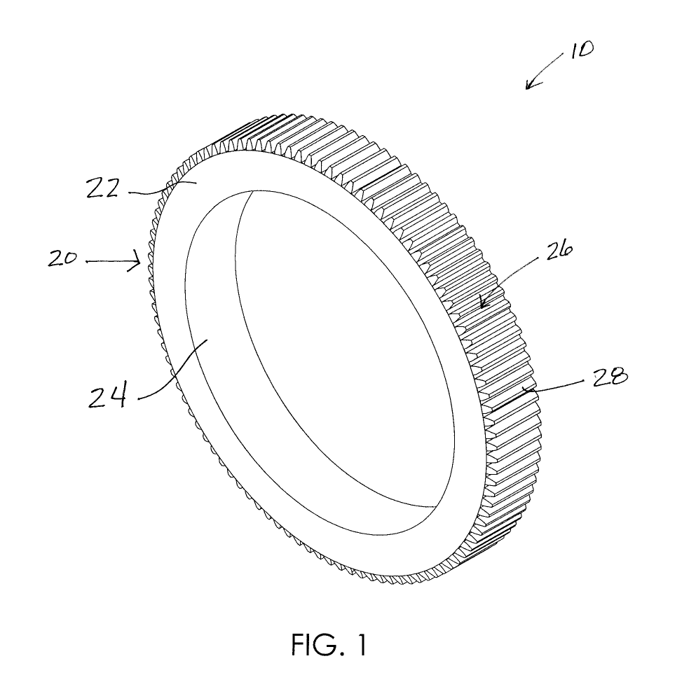

A follow focus apparatus for adjusting the focus of a camera lens according to the present invention will now be described in detail with reference to FIGS. 1 to 4b of the accompanying drawings. The follow focus apparatus 10 includes a gear ring 20 having an inner surface 24 defining an interior area and an opposed outer surface 26 having a plurality of teeth 28.

Referring to FIG. 1, the gear ring 20 of the follow gear apparatus 10 includes a front face 22 and an opposed rear face extending between the inner surface 24 and outer surface 26. The distance of the front face 22 between the inner surface 24 and outer surface 26 defines the thickness of the gear ring 20. Similarly, the distance of the inner surface 24 extending between respective front 22 and rear faces defines the width or depth of the gear ring 20. It is understood that gear rings according to embodiments of the present invention may include various selected thicknesses and widths suitable for desired applications. The plurality of teeth 28 are spaced apart a predetermined distance from one another along the outer surface 26 of the gear ring 20, each tooth extending between respective front and rear faces. In use, the inner surface 24 of the gear ring 20 may be coupled to a camera lens (not shown) in a friction or press fit relationship such that the camera lens is rotated in direct relationship to a rotation of the gear ring 20 by a user.

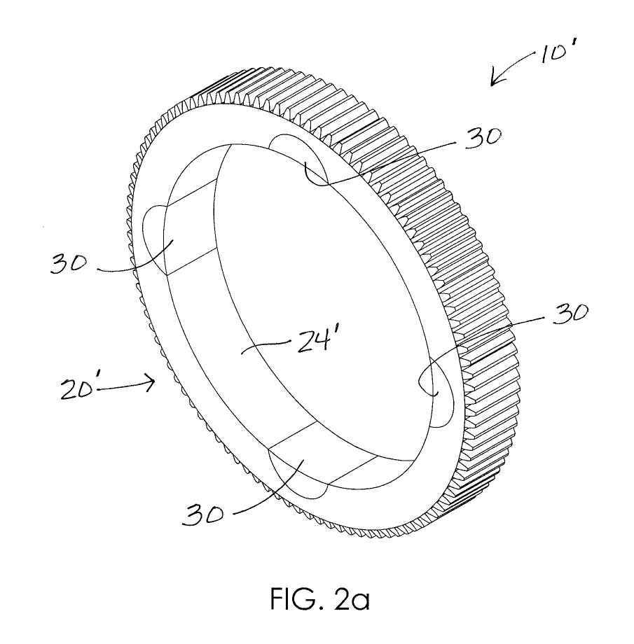

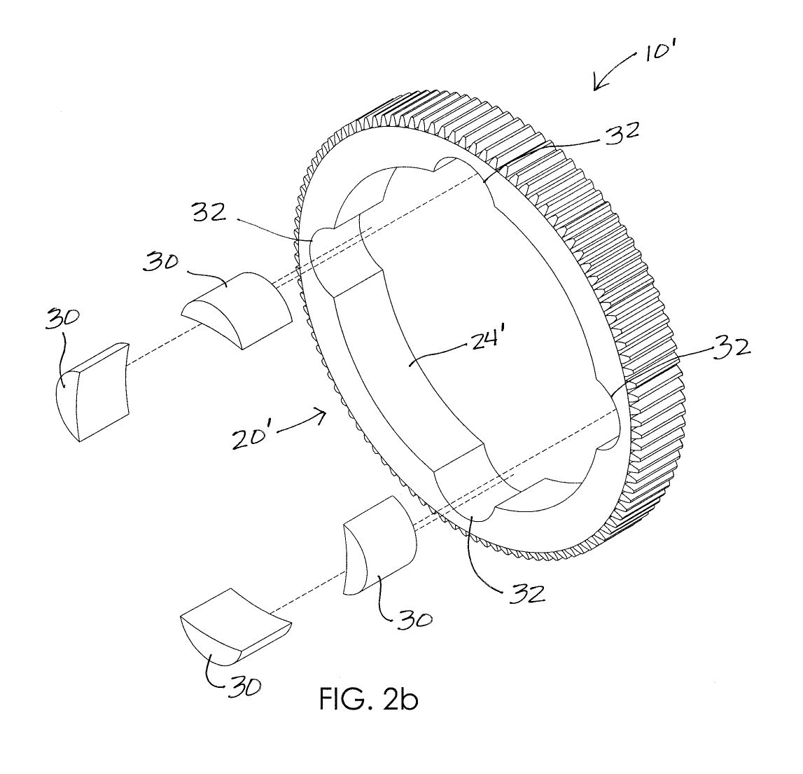

Primed reference numerals are used to denote elements that are substantially similar to corresponding structures described above. In an embodiment shown in FIGS. 2a and 2b, the follow focus apparatus 10′ includes a sizing member 30 that, when installed in the gear ring 20′, reduces an inner ring diameter of the interior area of the gear ring 20′, resulting in a tighter engagement with a camera lens or so as to fit a smaller camera lens altogether. In this embodiment, the inner surface 24′ of the gear ring 20′ defines at least one cutout area 32 configured to selectively receive the sizing member 30 in a nested relationship. Preferably, a plurality of sizing members 30 is provided, each sizing member 30 having the same configuration. Likewise, the inner surface 24′ of the gear ring 20′ may define a plurality of cutout areas 32, the cutout areas 32 being spaced apart from one another and each being configured to receive a respective sizing member 30 in a nested relationship. When nested, the one or plurality of sizing members 30 reduces the inner diameter of the gear ring by a predetermined amount such that the gear ring 30 is held in a friction grip relationship with a selected camera lens. As shown in FIGS. 2a and 2b, the sizing members 30 and corresponding cutout areas 32 may have a generally hemispherical configuration although other configurations may also work.

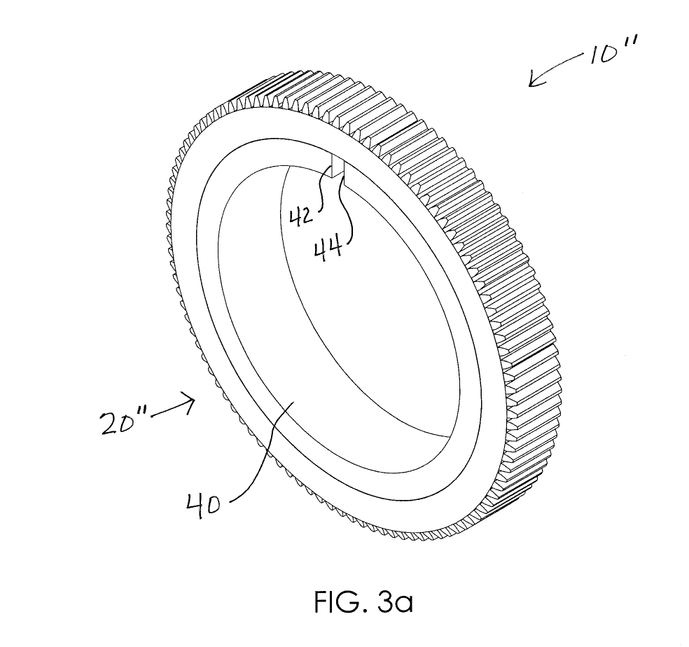

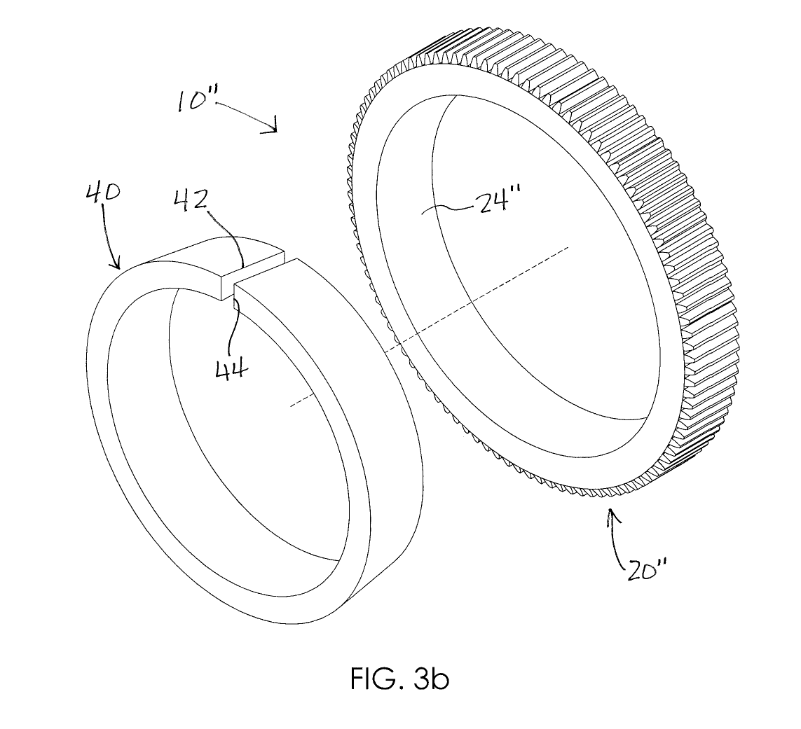

In an embodiment shown in FIGS. 3a and 3b, the follow focus apparatus 10″ may include a sizing ring 40 configured to be received in the interior area of the gear ring 20″ in a friction fit engagement. More particularly, the sizing ring 40 includes a generally circular shape that is congruent to the circular shape of the inner surface 24″ of the gear ring 20″. The sizing ring 40 defines an outer diameter that is substantially similar to the inner ring diameter of the inner surface 24″ of the gear ring 20″ such that sizing ring 40 is selectively positioned concentrically relative to the gear ring 20″. The sizing ring 40 includes a first end 42 displaced from a second end 44. The sizing ring 40 is constructed of a flexible material such that its diameter may be selectively decreased when inserting the sizing ring 40 into the interior area of the gear ring 20″. The sizing ring 40 is resilient to return to an unbiased diameter when pressure thereon is removed such that the sizing ring 40 fits tightly within the gear ring 20″.

In a related embodiment, the inner surface 24″ of the gear ring 20″ may not be uniform between respective front and rear faces thereof. For instance, an inner diameter of the gear ring 20″ adjacent the front face 22″ thereof may be greater than an inner diameter of the gear ring 20″ adjacent the rear face thereof such that the sizing ring 40 is easily received into the interior area from the direction of the front face 22″ and is received incrementally tighter as it is moved toward the rear face. Described another way, the sizing ring 40 may be inserted into the interior area of the gear ring 20″ from the direction of the front face 22″ and the decreasing diameter of the inner surface 24″ of the gear ring 20″ stop the sizing ring 40 from sliding out the other side, i.e. the side of the rear face. It is understood that the varied diameter may alternately be relative to an outer surface of the sizing ring rather than the inner surface 24″ of the gear ring 20″.

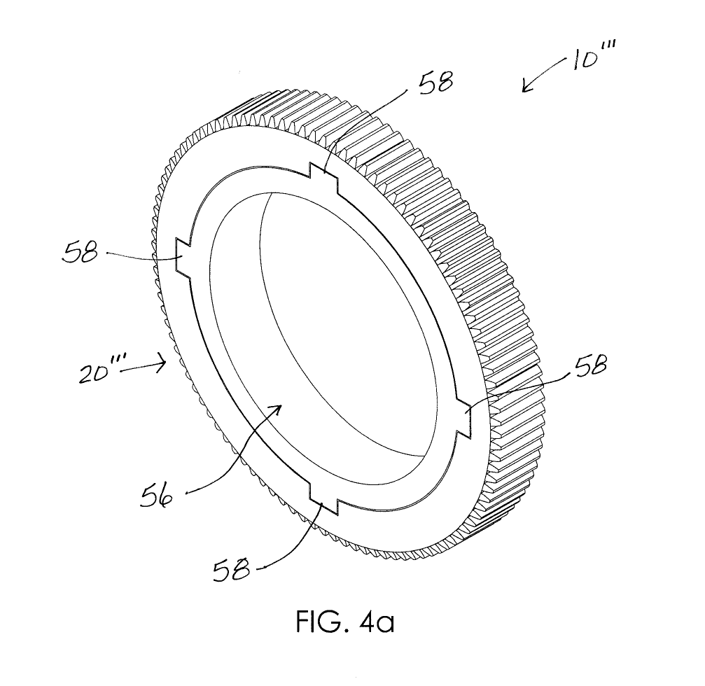

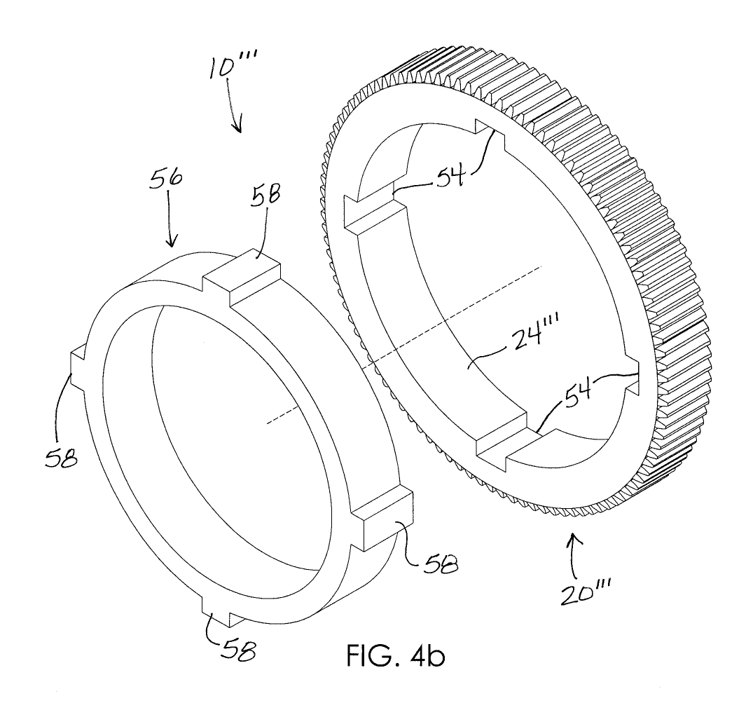

In an embodiment of the follow focus apparatus 10′ shown in FIGS. 4a and 4b, the inner surface 24′ of the gear ring 20″′ defines a recessed area 54, such as may be referred to as a notch. An auxiliary sizing ring 56 may have a complementary configuration, namely, a projection that extends outwardly from an outer surface of the auxiliary sizing ring 56. The recessed area 54 has a shape configuration that selectively receives the corresponding projection 58 in a friction fit engagement so that a rotation of the gear ring 20′ causes a corresponding rotation of the auxiliary sizing ring 56 nested therein.

Preferably, in the embodiment shown in FIGS. 4a and 4b, the inner surface 24″′ of the gear ring 20″′ defines a plurality of recessed areas 54 spaced apart from one another. Correspondingly, the auxiliary sizing ring 56 includes a plurality of projections 58, each extending outwardly from the ring's outer surface and spaced apart from an adjacent projection. Each recessed area 54 defines a shape configuration that selectively receives the corresponding projection 58 in a friction fit engagement so that a rotation of the gear ring 20″′ causes a corresponding rotation of the auxiliary sizing ring 56 nested therein. The plurality of recesses and corresponding recessed areas is advantageous in that it enhances a secure fit of the auxiliary sizing ring 56 within the interior area of the gear ring 20″′. As described above, the auxiliary sizing ring 56 may be provided in various inner diameter variations so as to adapt the gear ring 20″′ to fit correspondingly sized camera lenses.

In use, the gear ring 20 may be operatively coupled to a camera lens and operated rotatably to focus the lens. In various embodiments, sizing members 30, a sizing ring 40, or an auxiliary sizing ring 56 may be inserted into the interior area defined by the gear ring so that the gear ring may be coupled to camera lenses having smaller diameters.

It is understood that while certain forms of this invention have been illustrated and described, it is not limited thereto except insofar as such limitations are included in the following claims and allowable functional equivalents thereof.

1. A follow focus apparatus for adjusting the focus of a camera lens, comprising:
a gear ring that includes a cylindrical configuration having an inner surface, an outer surface opposite said inner surface and defining an open interior area, said inner surface having a planar configuration; and
a plurality of teeth situated on said outer surface of said gear ring and spaced apart from one another.

2. The follow focus apparatus as in claim 1, comprising:
a sizing member;
wherein:
said inner surface of said gear ring defines an inner ring diameter;
said inner surface of said gear ring defines a cutout area configured to selectively receive said sizing member in a nested relationship;
said sizing member has a configuration that reduces the inner ring diameter of said gear ring a predetermined amount when nested in said cutout area such that said gear ring is held in a friction fit relationship when selectively coupled to the camera lens.

3. The follow focus apparatus as in claim 1, comprising:
a plurality of sizing members;
wherein:
said inner surface of said gear ring defines an inner ring diameter;
said inner surface of said gear ring defines a plurality of cutout areas spaced apart from one another, each cutout area being configured to selectively receive a respective sizing member;
said each respective sizing member has a configuration that reduces the inner ring diameter of said gear ring a predetermined amount when nested in said each cutout area such that said gear ring is held in a friction fit relationship when selectively coupled to the camera lens.

4. The follow focus apparatus as in claim 2, wherein:
said sizing member has a generally hemispherical configuration; and
said cutout area has a generally hemispherical configuration that is selectively receives said sizing member in a friction fit engagement.

5. The follow focus apparatus as in claim 1, comprising a sizing ring having a generally circular shape that is congruent to a generally circular shape of said gear ring and having an outer diameter that is substantially similar to an inner diameter of said gear ring, said sizing ring being configured to selectively nest in said interior area of said gear ring in a friction fit engagement.

6. The follow focus apparatus as in claim 5, wherein said sizing ring has a first end separated from a second end and constructed of a generally flexible material such that a diameter to said sizing ring is selectively decreased when inserting said sizing ring into said interior area of said gear ring.

7. The follow focus apparatus as in claim 5 wherein said inner diameter of said gear member includes a front inner diameter adjacent a front face of said gear ring that is greater than a rear inner diameter adjacent a rear face of said gear ring such that said sizing ring is received into said interior area from a direction of said front face and received is received incrementally tighter adjacent a rear face of said gear ring.

8. The follow focus apparatus as in claim 5, wherein:
said inner surface of said gear ring defines a recessed area;
said sizing ring includes a projection extending outwardly from an outer surface thereof, said projection having a shape that is complementary to that of said recessed area such that said projection is selectively nested in said recessed area when said sizing ring is positioned in said interior area of said gear ring.

9. The follow focus apparatus as in claim 5, wherein:
said inner surface of said gear ring defines a plurality of spaced apart recessed areas;
said sizing ring includes a plurality of spaced apart projections extending outwardly from an outer surface thereof, each projection having a shape that is complementary to that of a respective recessed area such that said each projection is selectively nested in said respective recessed area when said sizing ring is positioned in said interior area of said gear ring.
